(19) United States
(12) Patent Application Publication
(10) Pub. No.: US 2005/0143054 A1
(43) Pub. Date: Jun. 30, 2005

(54) Method and apparatus for vocalizing characteristic ring signal of called party in a telephone system

(76) Inventor: Eliezer Fogel, Herzliya (IL)

Correspondence Address: NATH & ASSOCIATES, 1030 15th STREET, NW, 6TH FLOOR, WASHINGTON, DC, 20005, US

(21) Appl. No.: 10/747,173

(22) Filed: Dec. 30, 2003

(51) Int. Cl. H04M 3/42

(52) U.S. Cl. 455/415

(57) ABSTRACT

A fixed gateway for vocalizing a distinctive ring tone based on a called party, includes a memory storing data representative of a distinctive ring tone and an internal party number identifying each user associated with the gateway. A processor processes an incoming call to identity a called party; and a ring tone unit coupled to the processor and to the memory is responsive to the identity of the called party for vocalizing a respective ring tone based on the identified called party.

### FIELD OF THE INVENTION

This invention relates to “fixed” (PSTN or IP based) telephony. Within the context of the invention fixed telephony includes both corded and cordless telephones that operate on the fixed telephone network.

### BACKGROUND OF THE INVENTION

In a multi-user telephone system where multiple users have access to a common telephone extension or handset, it is liable to occur that an incoming call is answered by someone other than the party for whom the call is intended. In such case, the answering party has to locate the called party in the premises and transfer the call to him or her, or else take a message and try to remember to convey it to the intended party; or if he is less amenable he may request the calling party to phone again when the intended called party is expected to return.

A typical attempt to circumvent this problem, rather than solve it, is for a calling party to dial the cellular phone number of the intended call party. With the proliferation of cellular telephony, the cellular telephone has become a personal device. This has influenced increased use of the mobile telephone in two respects. First, personal information such as phone book, calendar and notes are stored and maintained in the mobile phone, thus making it that much easier for a calling party to dial, using his or her mobile phone without the need to commit target data to memory. Secondly, the surest way to reach a desired party is to dial his or her mobile telephone rather than risk dialing his or her fixed number and reaching another individual, e.g. her husband at home or coworker at office.

This trend also has some disadvantages. Use of fixed telephony has declined in the home and office as such phones are liable not to assure direct contact with the called party and do not support the personalization with the above-mentioned features. As a result, both the calling party and the called party are apt to carry their cellular phones on their person in order to facilitate dialing, on the one hand, and remaining in direct telephone contact, on the other. However, poor coverage and technical limitations of cellular telephony often reduce the quality of service, which is especially inferior to fixed telephony indoors. Thus, use of the cellular phone at home implies reduction in quality of communication.

Furthermore, cellular phones are mobile devices intended to be carried around on the move. As such, they are designed to be small and light, a constraint that implies a small screen, small keypad (buttons) and generally less than optimal ergonomic form. Hence the increased usage of the cellular phone, particularly by the called party, deprives the user of the convenience stemming from the larger size and well designed ergonomics of the telephone handset. Within the context of the description and the appended claims the term “telephone/telephone handset” refers to the handset commonly used at home and office, be it corded or cordless, while the term “mobile/cell phone” refers to cellular handset.

Commercially, the increasing trend to dial cellular to cellular for the reasons stated above reduces the use of the fixed telephone infrastructure (PSTN) and therefore its revenue. It is clearly in the interest of the fixed telephone service provider to maximize its revenue by encouraging greater use of the fixed infrastructure. In practice, this requires that the increased use of the cellular phone will not be at the expense of the fixed infrastructure.

U.S. Pat. No. 5,463,672 (Kage) published Oct. 31, 1995 and entitled “Personal mobile communications system having central station for paging mobile users via base stations” discloses a personal mobile communications system comprising base stations located in respective zones and a paging station covering an area including the zones, or cells. The paging station and all base stations are connected to a public switched telephone network (PSTN). When a call is originated from a PSTN user to a mobile user, the paging station receives a call-setup request from the PSTN containing the address codes of both PSTN and mobile users, and broadcasts the call-setup signal over the covered cells. One or more base stations receive the call-setup signal and, in response, broadcast an alert signal. One of the base stations receives an off-hook signal from the alerted mobile station and dials the PSTN user address code contained in the call-setup signal to the PSTN to establish a connection between the calling and called parties.

U.S. Pat. No. 5,787,365 (Rivero et al.) published Jul. 28, 1998 and entitled “Apparatus for combining cellular telephone ring signals and PSTN ring signals” discloses a ring detection device which signals a modem in a personal communication device. A detector is connected to the cellular telephone for detecting an incoming telephone call. An oscillator circuit generates a ringing signal for enabling a modem in response to either the cellular telephone incoming call or a ring signal received over a directly-connected PSTN network. The modem for the personal communication device responds for providing communication over either the cellular network or directly-connected PSTN network.

Both of these references relate to the integration of the cellular telephone and the PSTN network. However, neither appears to relate to a telephone gateway that allows a targeted PSTN telephone to be reached by dialing a known cellular telephone number. In particular, neither of these references teaches such a gateway that allows a distinctive ring signal to be vocalized so as to alert users of the targeted telephone that an incoming call is directed to one specific called party in a home or office environment where typically many users may access the same telephone handset.

It is also known in the art to group calling parties with the object of vocalizing an appropriate response based on the identity of a calling party. Thus, EP 1193955A2 in the name of Texas Instruments Inc. and entitled “Telephone personal information manager” published Apr. 3, 2002 describes a personal information manager for use in controlling telephone call message responses for a wireless communications network mobile station telephone. A telephone user programs a unique response for each calling party such as the normal audible alert, automatically transferring the call to voice mail, and silent ringing with no voice mail.

There is no suggestion to group called parties or to vocalize different alerts to the called party so as to allow multiple users of a common telephone handset to recognize for which party an incoming is intended.

Thus, it would be desirable to provide a more reliable indication of the identity of an intended called party so as to allow multiple users of a common telephone handset to recognize for which party an incoming is intended.

### SUMMARY OF THE INVENTION

It is therefore a principal object of the invention to provide an improved telephone gateway that gives a more reliable indication of the likely identity of an intended called party so as to allow multiple users of a common telephone handset to recognize for which party an incoming is intended.

A further object of the invention is to provide an improved telephone gateway that allows users to be reached on their telephones when they are at home or in the office even if the calling party dials their mobile phone number.

It is further an object to allow a calling party access to his personal information normally stored in his cell phone via the gateway.

It is a further object to provide such a gateway that allows a distinctive ring signal to be vocalized, so as to alert users of the gateway telephone extension(s) that an incoming call is directed to one specific called party in a home or office environment where typically many users may access the same telephone handset(s).

It is yet a further object of the invention to identify a likely targeted called party based on the identity of the calling party and to vocalize a corresponding distinctive ring signal.

It is further object of the invention to identify groups of individuals as a party having a common distinctive ring signal. The vocalized ring signal generated is that of the inclusive party. For example, in an office an inclusive party may be a team of workers; at home a party may be the parents etc. The grouping of individuals into an inclusive party and the grouping of inclusive parties into yet higher levels of inclusive parties may be based on user choice or may be automatic. The invention provides for a mechanism to vocalize the most likely party's ring signal, be it an individual party or an inclusive party.

It is a further object of the invention to enable call screening by generating a unique ring signal for unfamiliar callers.

It is another object of the invention to provide for automatic and manual management of common and individual phone lists, ring tones, and message boxes in the home/office gateway and to synchronize such information with the cellular maintained database.

These objectives are realized in accordance with a first aspect of the invention by a method for directing a telephone gateway serving multiple users to vocalize a distinctive ring tone based on a called party associated with the gateway, said method comprising:
(a) storing data representative of a distinctive ring tone and an internal party number identifying users associated with the gateway;
(b) processing an incoming call to identify a called party; and
(c) vocalizing a respective ring tone based on the identified called party.

According to another aspect of the invention there is provided a gateway for vocalizing a distinctive ring tone based on a called party, said gateway comprising:
a memory adapted to store data representative of a distinctive ring tone and a plurality of codes each identifying a respective called party associated with the gateway,
a processor for processing an incoming call to identity a called party, and
a ring tone unit coupled to the processor and to said memory and being responsive to the identity of said called party for vocalizing a respective ring tone based on the identified called party.

Preferably, the called party is identified by the cellular telephone to which an incoming call is directed, so that different users associated with the gateway may be identified by the attached cellular telephone. This allows a calling party to dial the cellular telephone number of a specific called party, while ensuring that the gateway vocalizes the ring tone associated with the specific called party and allowing that party to answer the incoming call using a fixed telephone connected to the gateway.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram showing functionally a system according to the invention;

FIG. 2 is a block diagram showing functionally a gateway for attaching cell phones and vocalizing a distinctive ring tone based on a called party in the system shown in FIG. 1;

FIG. 3 is a flow diagram showing the principal operations carried out by the gateway shown in FIG. 2 according to different embodiments of the invention;

FIG. 4 is a tabular representation showing the mapping of ring tone with caller ID and phone lists according to a preferred embodiment; and

FIGS. 5 and 6 are flow diagrams showing further operations carried out by the gateway shown in FIG. 2 according to different embodiments of the invention.

### DETAILED DESCRIPTION OF THE INVENTION

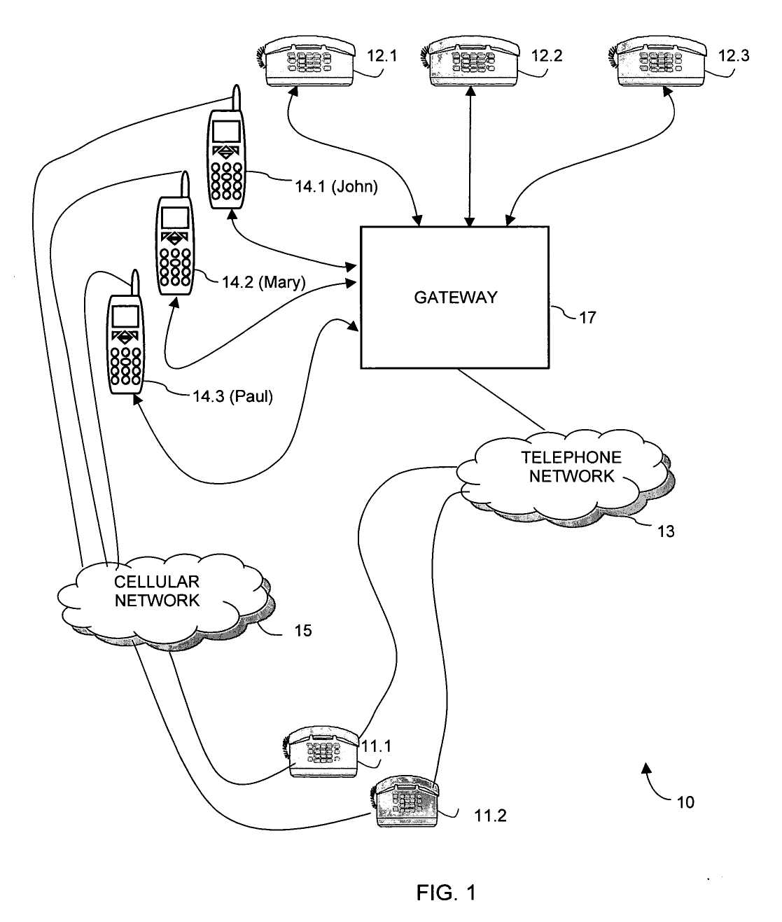

FIG. 1 shows a system designated generally as 10 for allowing one or more calling parties at source telephones 11.1 and 11.2 coupled to a PSTN or IP telephone network 13 or to Cellular network 15 to effect telephone communication with one or more called parties having respective target telephone handsets 12.1, 12.2 and 12.3, and who may also own a respective cell phone 14.1, 14.2 or 14.3, all coupled to a gateway 17. The cell phones allow their respective owners, i.e. 14.1 (John), 14.2 (Mary) and 14.3 (Paul) to be accessed directly and are connected by wire or wirelessly to the gateway 17 when their respective owners are in a location served by the Gateway 17, so as to create individual bridges between the cellular network 15 and the gateway 17. Furthermore, this connection allows for synchronization of the personal data in the cell phones with the personal data in the gateway and/or reflection of the personal data in the cell phones to the telephone handsets 12.1, 12.2 and 12.3. The telephone and cellular networks 13 and 15 respectively are shown in their most general form. Likewise, it is assumed that the telephone handsets 12.1, 12.2 and 12.3 are all fixed telephone type extensions that may be in different rooms in a house, office, factory or other building and may be used by one or more individuals. They may also be in different physical locations providing that they are all served by the same gateway 17. The present invention resides in the ability of the gateway 17 to process an incoming call directed to a cellular telephone number of a targeted party so as to accept the call, intone a characteristic ring signal, which allows a targeted party to discern therefrom that the incoming call is intended for him or her. Furthermore, the gateway 17 has the ability to identify or reasonably infer the intended party of a call emanating from a PSTN telephone and vocalize the corresponding ring tone.

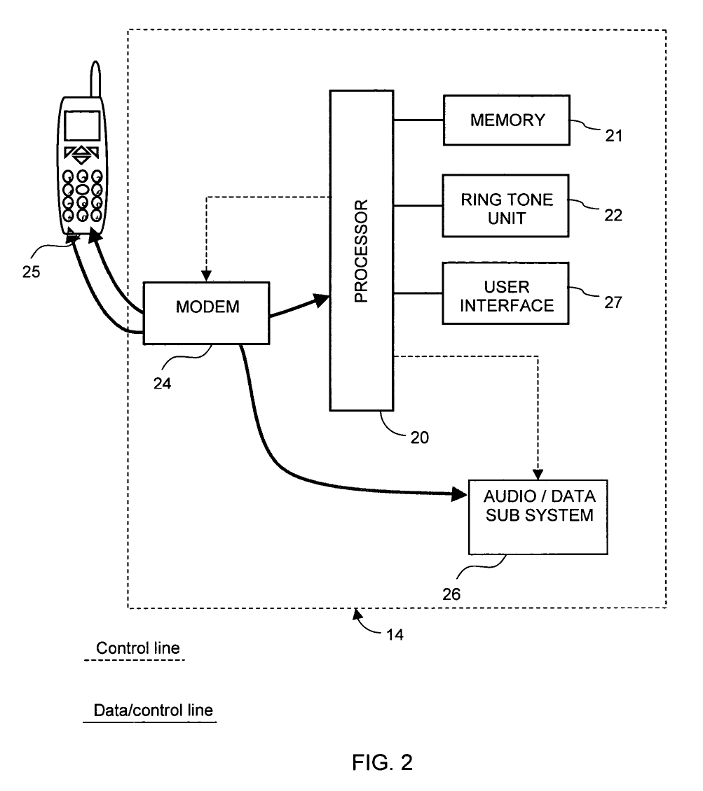

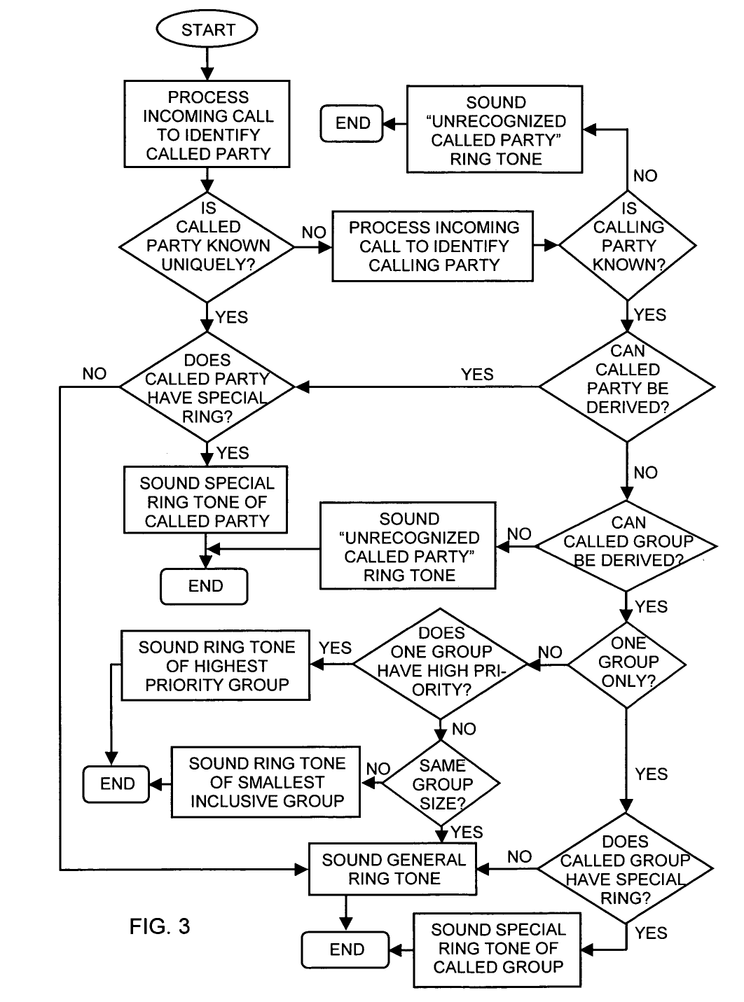

FIG. 2 is a block diagram showing functionally the gateway 17 for attaching one or more cell phones and vocalizing a distinctive ring tone based on a called party. FIG. 3 is a flow diagram showing the principal operations carried out by the gateway according to different embodiments of the invention.

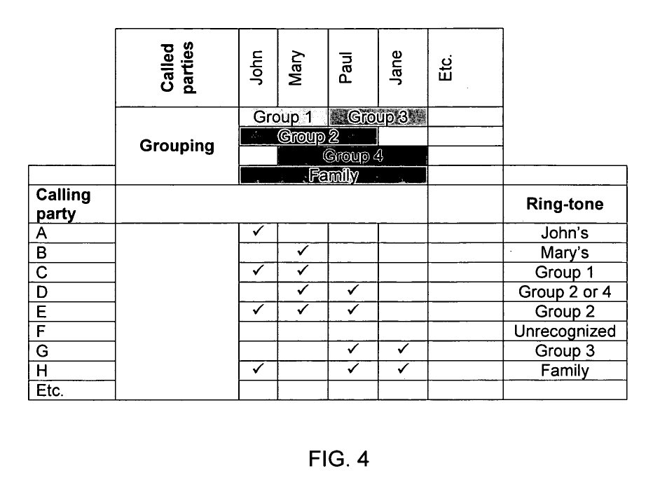

Thus, as shown in FIG. 2, the gateway 17 includes a processor 20 coupled to which are a memory 21 and a ring tone unit 22 as well as an interface to a modem 24 capable of communicating with a cellular phone 25. The modem 24 and its counterpart on the cell phone 25 may be hard wired (e.g. using the car adapter interface of a cell phone), or wireless (e.g. based on a Bluetooth air interface commonly available on cell phones), or Infrared-based (using the infrared interface available on cell phones). The memory 21 is adapted to store data representative of a distinctive ring tone, lists of personal telephone numbers identifying users or groups of users associated with the gateway as described in more detail below with reference to FIG. 4, and the identification number of the users' cellular phones. Also coupled to the processor are an Audio/Data subsystem 26, and a user interface 27 for allowing ring tones, user IDs and associated groups to be programmed into the memory 21. The ring tone unit 22 as well as the Audio/Data subsystem 26 and the user interface 27 may be part of the Gateway 17 or may be partially implemented in the corded or cordless extension as is the common art in implementing a corded/cordless telephone system.

FIG. 4 tabulates the possible different mapping of calling parties (A, B, C, . . . ) and intended/called parties (John, Mary, Paul, etc). This table also indicates a possible implementation of the decision process for ring tone selection using linked listing. Every column contains the list of caller IDs associated with a specific person—indicated by the check marks (✓). For example, A, C, E and H appear on John's phone list; B, C, D, E and G on Mary's list etc. Also, the table indicates grouping of individuals, into “parties”, such that John and Mary jointly are Group 1, John, Mary and Paul are Group 2, etc. and all the Gateway users are defined as “Family”. In the following description, FIG. 4 will be used to demonstrate the ring tone selection mechanism.

The processor 20 processes an incoming call emanating from the telephone network 13 to identity a likely called party, and the ring tone unit 22 is responsive to the identity of the called party for vocalizing a respective ring tone based on the identified called party. According to one preferred embodiment, ring tones are associated with each individual (John, Mary, Paul, etc.) as well as groups of individuals such as Group 1={John & Mary}, Group 2={John, Mary & Paul}, Group 3={Paul & Jane}, Group 4={Mary, Paul & Jane} etc. as well as the entire Family and “unrecognized caller” party. The user interface 27 permits the groups to be defined and for the ring tone data to be stored in the memory 21 for each group. The processor 20 also resolves ambiguity of intended called party by generating the ring tone of a called party that is uniquely associated with an identified calling party or of the smallest group containing all the individuals that may be the intended called party. A group ring tone allows each member of the respective group to recognize from the distinct ring tone that the call may be intended for him or her, while other users not in this group may safely ignore it. As a demonstration of such logic, the following rules may be applied based on the groupings shown in FIG. 4:
if A calls [symbol] John's ring tone is vocalized;
if B calls [symbol] Mary's ring tone is vocalized;
if C calls [symbol] Group 1's ring tone is vocalized since although John and Mary appear in both Groups 1 and 2 and also Family, Group 1 is the smallest group containing both John and Mary who have C in their respective phone lists;
if D calls [symbol] Group 2 or Group 4's ring tone is vocalized depending on their relative priority since Mary and Paul together appear in Groups 2, 4 and Family and Groups 2 and 4 are smaller than Family but are of equal size. If there is no predefined priority, the ring tone of either Group 2 or Group 4 may be vocalized according to any other established criterion. Alternatively, the ring tone of the smallest inclusive group containing all members of both groups 2 and 4 may be vocalized (in this case, Family);
if E calls [symbol] Group 2's ring tone is vocalized;
if F calls [symbol] the “unrecognized caller” party ring tone is vocalized;
if G calls [symbol] Group 3's ring tone is vocalized since Paul and Jane are in Group 3, Group 4 and in Family, but Group 3 is the smallest; and
if H calls [symbol] Family ring tone is vocalized because only this Group contains John, Paul and Jane.

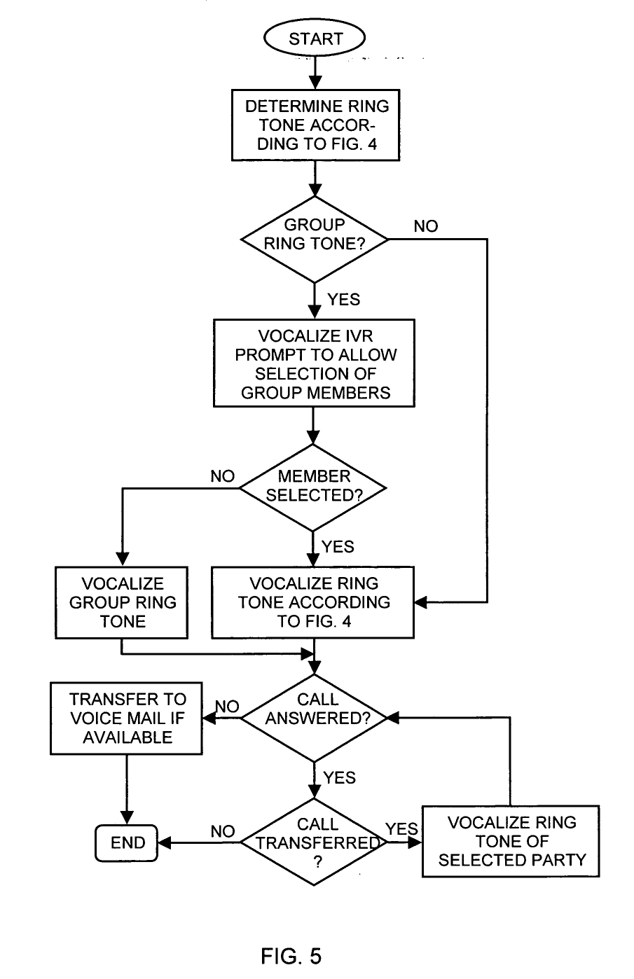

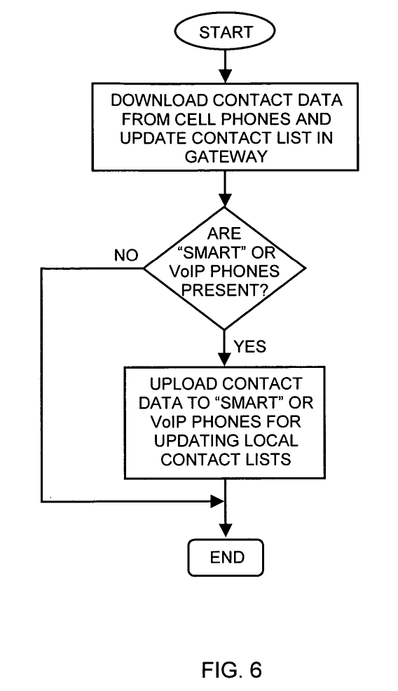

FIGS. 5 and 6 are flow diagrams showing further operations carried out by the gateway shown in FIG. 2 according to different embodiments of the invention. As shown, the processor 20 also processes calls received on the personal cell phones 14.1, 14.2 and 14.3 attached to the gateway 17 via the modem 24, to activate the ring tone unit 22 and vocalize the cell phone owner individual ring tone. For example, if a call is received on cell phone 14.2 owned by Mary, the modem 24 signals the processor 20, which reads from the memory the data corresponding to Mary's ring tone and conveys the ring tone to the ring tone unit 22 where it is vocalized.

Furthermore, the processor 20 controls the telephony audio and data path to/from the extension 12.x responding to the call from/to the cell phone 25. The processor 20 also controls the communication path allowing a call initiated on one of the gateway extensions to be routed to the fixed telephone network 13 or the Cellular network 15 via the attached cell phone, in accordance with the user prioritization.

The processor 20 also communicates with the attached cell phones 14.1, 14.2 and 14.3 via the modem 24 and may be programmed (or operate in conjunction with suitable firmware) to allow for synchronization of the personal database in the memory 21 with the corresponding personal data stored in the respective cell phones 14.1, 14.2 and 14.3. Alternatively, the processor 20 may enable direct access by the user to the data in the cell phones 14.1, 14.2 and 14.3 via the Audio/Data subsystem 26 and the modem 24. To this end, data in the memory of the cell phone may be read by the Audio/Data subsystem 26. Such functionality may be based on common car kit interfaces available on cellular phones or based on a wireless interface such as the Bluetooth standard interface utilizing one or more of its profiles such as Hands-free profile, OBEX (object exchange) profile, SIM Access profile and the like.

As shown in FIG. 6, the processor 20 may also be adapted to synchronize or otherwise reflect the phone lists of an attached cellular phone with the corresponding individual list in the gateway, to allow for representation of the combined phone list to the user when he or she is using one of the telephone handsets 12.1, 12.2 or 12.3. In the case of regular PSTN handsets, this requires a suitably programmed “smart” telephone having a display and suitable scroll buttons. This is well within the competence of the skilled artisan since cordless phones already possess the required interface and functionality. However, the invention also contemplates the use of VoIP telephones which are may be realized using a programmed computer connected to the Internet or an IP Phone. In such case, the computer/IP Phone may be suitably programmed to provide the desired functionality.

The processor 20 may be further adapted to allow a call picked up by one user to transfer the call to another selected user and to vocalize the characteristic ring tone of the selected user. To this end, the processor 20 identifies a selected internal party input by a user who has answered an incoming call and who wishes to transfer the call to the selected internal party and to terminate the call to the user who answered the incoming call on any of the extensions 12.1, 12.2 or 12.3. The ring tone unit 22 then vocalizes the characteristic ring tone based on the identified internal party. The same method may be used to enable internal (intercom) call initiation by any user from any of the extensions when the desired party's location in the house or office is not known.

According to another embodiment, the memory 21 is adapted to store data representative of at least one calling party associated with one or more users associated with the gateway 17. To this end, the user interface 27 may be used to scroll through a list of users (e.g. mother, father, daughter, son) and to enter for each user one or more telephone numbers of friends and other contacts to be stored in the memory and indexed against the respective user. As explained above with reference to FIG. 4, some contacts may appear in more than one list. The processor 20 is adapted to process an incoming call to identify a calling party, using Caller-ID for example, and to identify a most-likely called party based on the identified calling party. The ring tone unit 22 is adapted to vocalize the ring tone based on the identified most-likely called party. For example, referring to FIG. 4 even if “A” dials the PSTN number of John rather than John's cell phone number, the processor 20 identifies the incoming call as originating from “A” who is associated with John. On this basis, even though in this case the called party was not identified from the number dialed by the calling party (since the PSTN number of John's household or office was dialed rather than his mobile number), the processor 20 is still able to determine unambiguously that the call is destined for John and to ensure that the ring tone unit 22 vocalizes the correct ring tone. A similar unambiguous situation also applies to B in FIG. 4 who is associated uniquely with Mary.

In those cases where the number of a calling party appears in more than one list (all callers in FIG. 4 except A, B and F), it is not possible to correlate the calling party unambiguously with a single called party. To cover for this possibility, there may be established a priority listing that indicates to which group member a call is to be directed when the called party cannot be uniquely identified and when the calling party appears in the “contact lists” of more than one party.

Upon processing an incoming call for which a unique called party cannot be determined but for which a calling party may be identified who is associated with more than one group, the processor 20 is adapted to determine the smallest group containing all possible called parties associated with the identified calling party; and the ring tone unit is adapted to vocalize the ring tone 22 based on the smallest group thus identified.

If all of the possible called parties associated with the calling party appear in more than one group and no group priority can be established and all the associated groups are the same size, the ring tone unit 22 may be adapted to vocalize a ring tone of the smallest inclusive group containing all members of all groups containing all possible called parties. For example, if D calls and there is no predetermined priority to permit unambiguous selection of Group 2 or Group 4, the general ring tone may be vocalized since Family is the all inclusive group containing all members of all Groups 2 and 4. Similarly, if the calling party is either not associated with a unique called party or is associated with multiple called parties that do not belong to any group, such as H in FIG. 4, the general ring tone may be vocalized. However, if the calling party does not appear in any of the user's lists, e.g. caller F, the ring tone unit may be adapted to vocalize a distinctive “unrecognized caller” ring tone.

In a domestic environment, as described above, although multiple handsets are commonly provided, these are usually accessible to all parties since the only way to assign a handset to a specific called party is by allocating extensions using an internal exchange. On the other hand, in an office environment, extensions are commonly provided so as to allow a calling party to reach a specific called party by dialing a general number to contact the workplace and then entering or requesting an extension in order to transfer the call to the desired extension. The invention still finds application in such an environment because, particularly albeit not only, in open-plan offices more than one employee may share the same extension. In such case, the invention allows a distinctive ring tone to be vocalized so as to indicate the called party, when this can be established. This saves a co-worker answering a call that he knows is not for him and acting as a secretary for his colleague, when the calling party can just as easily leave a voice mail message without disturbing the intended called party's co-worker.

Moreover, in an environment where called parties are associated with extension handsets, the gateway 14 may be adapted to transfer an incoming call directly to a specific handset based on the identity of the called party, when known; or based on the identity of the calling party where the identity of the called party cannot be uniquely determined. In this case, groups may be associated not only with different calling parties as described above, but also with different called parties. Such “called party groups” share one or more extension handsets thus allowing a distinctive ring tone to be vocalized in respect of an incoming call destined to a specific extension. This avoids the confusion particularly, but not only, in open-plan offices where the telephone rings with a standard ring tone, and it is often difficult to discern for whom the incoming call is intended.

In another preferred embodiment of the invention, when the called party is not unique and thus an inclusive ring tone is generated, the gateway may further generate a vocal response to the calling party giving the party the choice to dial the extension number of one of the individuals in the matching group. For example, with reference to FIG. 4, when C calls, the Group 1 ring tone is first vocalized and in parallel C will hear a verbal prompt to select John's or Mary's extension number if he so wishes. If C dials John's or Mary's extension number before the call is answered on one of the handsets, the ring tone will change to the selected party.

If a call is not answered, the call is transferred to the mail box of the preferred targeted party, be it an individual or a group of individuals according to the logic used for vocalizing the ring tone.

In practice, the gateway 17 may be a suitably programmed computer. Likewise, the invention contemplates a computer program being readable by a computer for executing the method of the invention. The invention further contemplates a machine-readable memory tangibly embodying a program of instructions executable by the machine for executing the method of the invention. Furthermore, as has already been noted above, one or more of the handsets 12.1, 12.2 and 12.3 may be suitably programmed computers for allowing VoIP telephony.

1. A method for directing a telephone gateway serving multiple users to vocalize a distinctive ring tone based on a called party associated with the gateway, said method comprising:
(a) storing data representative of a distinctive ring tone and an internal party number identifying users associated with the gateway;
(b) processing an incoming call to identify a called party; and
(c) vocalizing a respective ring tone based on the identified called party.

2. The method according to claim 1, wherein processing an incoming call to identify a called party includes:
i) mapping identities of cellular telephones coupled to the gateway to respective users associated with said gateway;
ii) determining an identity of one of said cellular telephones to which an incoming call is directed; and
iii) using the identity of the cellular telephone to identify the called party.

3. The method according to claim 1, further including:
(d) identifying an internal party input by a user who has answered an incoming call and who wishes to transfer the call to said internal party;
(e) terminating the call to said user; and
(f) vocalizing a respective ring tone based on the identified internal party.

4. The method according to claim 1, wherein processing an incoming call to identify a called party includes:
i) associating at least one calling party with one or more users of the gateway;
ii) processing an incoming call to identify a calling party;
iii) identifying all possible called parties associated with the identified calling party; and
iv) identifying a most-likely called party;
the vocalized ring tone being based on the identified most-likely called party.

5. The method according to claim 4, wherein processing an incoming call to identify a called party includes:
i) associating at least one group with multiple possible called parties of the gateway;
ii) associating a respective distinctive ring tone with each of said groups; and
iii) determining the smallest group associated with the identified calling party that contains all possible called parties associated with the identified calling party;
the vocalized ring tone being based on said smallest group.

6. The method according to claim 5, wherein vocalizing the ring tone includes:
i) if only one called party is associated with the calling party, then vocalizing the respective ring tone of said called party; else ii) if all of the possible called parties associated with the calling party appear in only one group, then vocalizing the respective ring tone of said one group; else iii) if all of the possible called parties associated with the calling party appear in more than one group, then using a priority order associated with said groups so as to identify a preferred group and vocalizing the respective ring tone of the preferred group; else iv) if all of the possible called parties associated with the calling party appear in more than one group and no priority can be established with said groups, then vocalizing a ring tone of the smallest unique inclusive group ring tone containing all members of all identified groups;
v) if no user or user group can be associated with the calling party, then vocalizing a distinctive “calling party unrecognized” ring tone.

7. The method according to claim 1, further including:
(d) defining at least one called party group identifying at least two called parties having access to a common telephone handset;
(e) identifying a called party group associated with an identified called party;
(f) directing an incoming call that is intended to said called party group to the common telephone handset associated therewith.

8. The method according to claim 7, further including:
(g) vocalizing an IVR prompt for directing the calling party to select one of the called parties associated with the identified called party group; and
(h) upon selection by the calling party of a called party, vocalizing the ring tone of the selected called party.

9. The method according to claim 2, further including:
(d) reading personal contact data stored in a memory of one or more of said cellular telephones; and
(e) conveying said personal contact data to a telephone handset or to a VoIP phone associated with said one or more of cellular telephones for display.

10. A gateway for vocalizing a distinctive ring tone based on a called party, said gateway comprising:
a memory adapted to store data representative of a distinctive ring tone and a plurality of codes each identifying a respective called party associated with the gateway,
a processor for processing an incoming call to identity a called party, and
a ring tone unit coupled to the processor and to said memory and being responsive to the identity of said called party for vocalizing a respective ring tone based on the identified called party.

11. The gateway according to claim 10, wherein:
a modem is coupled to the processor for enabling attachment and communication of cellular telephones to the gateway,
the memory is adapted to store a respective cellular telephone number associated with users associated with the gateway, and
the processor is adapted to identify a cellular telephone number to which an incoming call is directed and to identify the called party based on the identified cellular telephone number.

12. The gateway 10, wherein:
the processor is adapted to identify an internal party input by a user who has answered an incoming call and who wishes to transfer the call to said internal party and to terminate the call to said user; and
the ring tone unit is adapted to vocalize a respective ring tone based on the identified internal party.

13. The gateway according to claim 10, wherein;
the memory is adapted to store data representative of at least one calling party associated with one or more users associated with the gateway;
the processor is adapted to process an incoming call to identify a calling party, and to use the identified calling party to identify a most-likely called party; and
the ring tone unit is adapted to vocalize the ring tone based on the identified most-likely called party.

14. The gateway according to claim 13, wherein:
the memory is adapted to store data representative of at least one group associated with multiple called parties associated with the gateway and of a respective distinctive ring tone associated with each group, each of said groups also being associated with one or more calling parties;
the processor is adapted to determine the smallest group associated with the identified calling party; and
the ring tone unit is adapted to vocalize the ring tone based on the smallest group associated with the identified calling party that contains all possible called parties associated with the identified calling party.

15. The gateway according to 14, wherein:
the memory is adapted to store a priority order associated with said groups so as to identify a preferred group corresponding to an identified calling party who is associated with more than one group having an equal number of members as said smallest group.

16. The gateway according to 14, wherein:
the ring tone unit is adapted to vocalize a ring tone of the smallest unique inclusive group ring tone containing all members of all identified groups if the calling party appears in more than one group and no priority can be established with said groups.

17. The gateway according to 14, wherein:
the ring tone unit is adapted to vocalize a distinctive “calling party unrecognized” ring tone if no user or group is associated with the calling party.

18. The gateway according to claim 10, wherein:
the memory stores data defining at least one called party group identifying at least two called parties having access to a common telephone handset; and
the processor is adapted to determine a called party group associated with an identified called party; and to direct an incoming call that is intended to said called party group to the common telephone handset associated therewith.

19. The gateway according to claim 18, wherein:
the memory stores data relating to a voice message for prompting the calling party to select one of the called parties associated with said called party group; and
the ring tone unit is responsive to a selected called party for vocalizing the respective ring tone thereof.

20. The gateway according to claim 11, wherein:
the processor is adapted to read personal contact data stored in a memory of one or more of said cellular telephones and to convey said personal contact data to a telephone handset or to a VoIP phone associated with said one or more of cellular telephones for display.

21. A program storage device readable by machine, tangibly embodying a program of instructions executable by the machine to perform method steps for directing a telephone gateway serving multiple users to vocalize a distinctive ring tone based on a called party associated with the gateway, said method comprising:
(a) storing data representative of a distinctive ring tone and an internal party number identifying users associated with the gateway;
(b) processing an incoming call to identify a called party; and
(c) vocalizing a respective ring tone based on the identified called party.

22. A computer program product comprising a computer useable medium having computer readable program code embodied therein for directing a telephone gateway serving multiple users to vocalize a distinctive ring tone based on a called party associated with the gateway, said computer program product comprising:
computer readable program code for causing the computer to store data representative of a distinctive ring tone and an internal party number identifying users associated with the gateway;
computer readable program code for causing the computer to process an incoming call to identify a called party; and
computer readable program code for causing the computer to vocalize a respective ring tone based on the identified called party.
